(19) United States
(12) Patent Application Publication
(10) Pub. No.: US 2026/0261031 A1
(43) Pub. Date: Sep. 3, 2026

(54) SYSTEM OF RADIO-FREQUENCY TECHNOLOGY

(71) Applicants: FRIEDRICH-ALEXANDER UNIVERSITÄT ERLANGEN-NÜRNBERG, KÖRPERSCHAFT DES ÖFFENTLICHEN RECHTS, Erlangen (DE); IWIS SMART CONNECT GMBH, Rieden am Forggensee (DE)

(72) Inventors: Konstantin LOMAKIN, Nürnberg (DE); Andreas HOFMANN, Erlangen (DE); Gerald GOLD, Erlangen (DE); Mark SIPPEL, Fürth (DE); Harald WURSTER, Rieden am Forggensee (DE)

(21) Appl. No.: 19/165,022

(22) PCT Filed: Mar. 13, 2024
(86) PCT No.: PCT/EP2024/056681

§ 371 Date: Jan. 30, 2026

(30) Foreign Application Priority Data
Mar. 14, 2023 (DE) 10 2023 106 345.6

(51) Int. Cl. H01P 5/00; H01P 3/12

(52) U.S. Cl. CPC H01P 5/00; H01P 3/12

(57) ABSTRACT

The present invention relates to a system of radio-frequency technology comprising a waveguide, a component and a connector that is formed and arranged such that it connects the waveguide to the component, the connection comprising a mechanical connection, and the connection produced by the connector being a connection suitable for radio-frequency.

### CROSS REFERENCE TO RELATED APPLICATIONS

The present application is a U.S. National Phase of International Application No. PCT/EP2024/056681 entitled “SYSTEM OF RADIO-FREQUENCY TECHNOLOGY”, and filed on Mar. 13, 2024. International Application No. PCT/EP 2024/056681 claims priority to German Patent Application No. 10 2023 106 345.6 filed on Mar. 14, 2023. The entire contents of each of the above-listed applications are hereby incorporated by reference for all purposes.

### TECHNICAL FIELD

The present invention relates to a system of radio-frequency technology with a waveguide, a component, and a connector that is designed and arranged in such a way as to establish a connection between the waveguide and the component, wherein the connection comprises a mechanical connection.

### BACKGROUND AND SUMMARY

According to the prior art, a mechanical connection of a waveguide to a circuit board and/or to another waveguide is achieved by screwing, soldering, and/or gluing. In addition, a radio-frequency suitable electrical connection, i.e. one suitable for transmitting radio-frequency electromagnetic waves, is provided between the individual components.

It is already known in the prior art that waveguides or waveguide components can be mechanically connected to a circuit board, a carrier, or another system by means of press-fit zones or stamped parts. However, the focus in the prior art is always on the mechanical aspect of the connection.

The mechanical connection is often functionally separate from the electrical connection, since, for example, screws are not designed to transmit radio-frequency electromagnetic waves. The mechanical connection is often also located far from the transition region designed for transmitting radio-frequency electromagnetic waves.

A radio-frequency suitable electrical connection requires high mechanical precision. For example, it must be ensured that the waveguide lies flush against the circuit board in all areas, otherwise there is a risk of mismatch at the transition. The production of a radio-frequency suitable electrical connection is particularly challenging in mass production, since such connections require tight tolerances. Even in individual fabrication, such connections are not trivial and often require the application of a defined torque (e.g., with coaxial connections), despite precise, flat-polished contact surfaces. This is particularly challenging in mass production, especially in the multi-gigahertz range, where gaps in the double-digit um range can already determine the functionality of the contact point.

Soldered and/or glued connections often exhibit the problem that the waveguide “floats” during the soldering and/or gluing process and is no longer positioned precisely. The production of mechanical and electrical connections of waveguides to each other or to circuit boards is therefore very expensive.

Against this background, the object of the present invention is to further develop the above-mentioned system of radio-frequency technology in such a way that an improved connection between a waveguide and a component is achieved, which can be used reliably, in particular, in serial and mass production.

This object is achieved by the subject matter described herein.

According to the invention, the connection established by the connector comprises a radio-frequency suitable connection.

The connector is therefore preferably involved in signal transmission.

It is preferably provided that the connection also directly integrates the radio-frequency aspect. The stamped part, which is pressed into (for example) plastic, is simultaneously involved in signal transmission-in other words: it interacts with the electromagnetic waves of the system of radio-frequency technology and thereby becomes a radio-frequency component.

The system of radio-frequency technology is preferably designed in such a way that at least in certain regions, a radio-frequency electromagnetic wave, in particular with a frequency above 3 MHz, can be guided.

It may also be provided that the system of radio-frequency technology comprises more than one waveguide, more than one component, and/or more than one connector. In particular, it is conceivable that a connection between the waveguide and the component is established by more than one connector.

It is also conceivable that the system of radio-frequency technology comprises an antenna array consisting of several antennas, as well as an associated feed and/or distribution network.

It is preferably provided that the connector is a part that comprises or is a contour produced by shearing and/or laser cutting and/or a screw. The screw can also be a micro-screw. The screw may have a thread diameter between 0.1 mm and 3 mm, preferably between 0.5 mm and 2 mm, in particular between 1 mm and 2 mm.

In other words, the connector is preferably a stamped part. Stamped parts exhibit high precision. The connector may be produced by forming, for example by bending and/or shearing.

The component is preferably a radio-frequency and/or electrical component.

The waveguide is preferably designed in such a way that a radio-frequency electromagnetic wave, in particular with a frequency above 3 MHz, can be transmitted.

Within the framework of this invention, “electrical” preferably includes both electrical and/or electronic.

It is preferably provided that the connection comprises an electrical connection.

A radio-frequency suitable connection is preferably a connection that is at least partially suitable for transmitting radio-frequency electromagnetic waves. The connector is therefore preferably designed in such a way that it can guide a radio-frequency electromagnetic wave at least in one region and/or, in interaction with the waveguide to be connected, creates a geometry that can guide a radio-frequency electromagnetic wave and/or favors its guidance.

Depending on the arrangement of the connector, it may participate in the transmission of the radio-frequency electromagnetic wave, i.e. form part of the transmission path or not. “Radio-frequency suitable” also includes the case in which the connector is not part of the transmission path of the radio-frequency electromagnetic wave.

It is conceivable that the connector, or the elements defining the connector and/or stamped parts, tangentially touch or even intersect the cross-sectional geometry of the inner sides of the waveguide at one or more points. In particular, it is conceivable that the connector continues the contour of the waveguide in the propagation direction at one or more points of the cross-sectional geometry. The area traversed by a radio-frequency electromagnetic wave during transmission from component to component, i.e. from waveguide to component, preferably via the connector, can be referred to as the transition region.

Preferably, a connection is made by a stamped connector, in particular comprising pins or plugs directly in the transition region between waveguide and component.

The connector is preferably part of the transition region.

The connector preferably establishes both a mechanical and a radio-frequency suitable connection in one technology and in one step. It is also conceivable to focus on the quality of signal transmission (electromagnetic focus) in the transition region and to realize the mechanical requirement elsewhere in the connection of the two components by approaches known from the prior art.

The invention has the advantage that a mechanical connection by means of a connector is a proven technology already used in mass markets.

The transition region preferably exhibits very good matching and is particularly stable and tolerant with respect to displacements of the waveguide in all directions, in particular perpendicular to the circuit board. Here, “stable and tolerant” preferably means that small changes, e.g. in the range of several 100 μm, or deviations from the ideal geometric fit and/or positioning do not lead to malfunction of the transition from an electromagnetic perspective, in particular the signal transmission.

Preferably, a connection of two waveguides and/or a waveguide with a component is made via one or more connectors, wherein the connectors are arranged near the transition region or form part of the transition region.

The connector may be at least partially part of the transition region or not part of it. The waveguide walls may lie flush on the component and thus shield the connector.

It is preferably provided that the component comprises or consists of a waveguide, a circuit board and/or a package and/or is manufactured by an additive manufacturing process.

Preferably, a connection of a waveguide with a circuit board and/or another waveguide is established. The circuit board may be part of a package comprising an integrated circuit (IC) and a housing.

The component may comprise or consist of a molded interconnect device (MID), preferably three-dimensional.

It is conceivable that the connector, the waveguide and/or the component have a bore. The connector, the waveguide and/or the component may also have another opening.

It is also conceivable that recesses are provided in the model of the waveguide and/or the waveguide system for the elements of the connector. Such recesses may already be provided on the circuit board and/or the component to be connected. This can improve the fit accuracy and/or favor the mechanical connection quality with respect to service life or strength.

It is preferably provided that the waveguide and/or the component has a recess, the recess being designed and arranged in such a way as to enable insertion of at least a portion of the connector into the recess.

It is preferably provided that at least one element of the connector with at least one of its contours touches and/or cuts the cross-section of the waveguide and/or is part of the cross-sectional geometry.

It is preferably provided that the at least one element of the connection is designed as a flat sheet, similar to a blade, having a thickness of less than 1 mm, preferably less than 600 μm, and in particular less than or equal to 500 μm.

It is preferably provided that the at least one waveguide and/or the at least one element of the at least one connector has a chamfer and/or a preferably gradual shape change in the region of the connection.

It is preferably provided that at least one element of the at least one connector comes into contact with the electromagnetic wave guided by the waveguide in whose vicinity the connector is placed.

It is preferably provided that the at least one element of the at least one connection protrudes over a certain length, in particular measured perpendicular to the circuit board plane, into the waveguide and/or into the material forming a waveguide system, wherein said length is less than 10 mm, preferably less than 5 mm, and in particular less than 1 mm.

It is preferably provided that the at least one connector contributes to impedance matching in the transition region.

It is preferably provided that at least one element of the connector engages, projects into, and/or interlocks in a toothed manner with the body of a waveguide system, not necessarily into the waveguide cross-section, but also merely into the plastic body from which the waveguide or the waveguide system is made.

It is preferably provided that the connection consists of at least one and preferably several elements, and that these elements preferably mimic and/or reproduce the waveguide channel with their contours facing the waveguide channel conducting the wave, and/or are arranged tangentially to it in the propagation direction of the electromagnetic wave, i.e. perpendicular to the circuit board plane.

It is preferably provided that by one or more connectors or elements of a connector, the contour of a wall guiding longitudinal currents in the propagation direction of the waveguide is formed in the propagation direction and/or functions as such at at least one point of the waveguide cross-section.

It is preferably provided that the fit of the waveguide on the component, or the fit of the waveguide system on the circuit board, is not ideally aligned but exhibits an offset, wherein the offset in the circuit board plane is less than 1 mm, preferably less than 500 μm, and in the direction perpendicular to the circuit board is also less than 1 mm, preferably less than 500 μm.

It is preferably provided that in the region of the connection there is a gap, in particular an air gap.

It is preferably provided that a widening of the waveguide cross-section is provided in the region of the transition, in particular with the aim of reducing the requirements on fit accuracy, in that the widening of the waveguide cross-section does not restrict the original waveguide cross-sectional area if an offset should occur in the circuit board plane.

The waveguide cross-section is preferably determined by the frequency. It is conceivable that the higher the intended frequency, the smaller the dimensions.

The waveguide preferably has, for the range of 60 to 110 GHz, a broad side of about 2.5 mm to 3.1 mm and a narrow side of 1.27 mm to 1.55 mm. However, this is not to be regarded as limiting. Waveguides with other dimensions and/or with other frequency ranges are also encompassed by the invention.

It is conceivable that the connector comprises a plug contact, a press-fit zone, and/or a barb.

By means of a bore in the waveguide and a barb and/or a press-fit zone of the connector, the connector can preferably be connected to the waveguide by engaging the barb and/or the press-fit zone into a bore of the waveguide.

The waveguide and/or the at least one element of the at least one connector in the region of the connection may be chamfered and/or have a preferably gradual shape change. This can serve both the mechanical fit, assembly, and radio-frequency adaptation of impedance and/or the signal.

It is conceivable that the elements of the connector are interlocked in the waveguide, or gradually merge into each other via teeth. Preferably, corresponding recesses are already provided in the waveguide model in order to improve mechanical strength and to avoid unnecessary distortions during press-fitting and/or to favor fit accuracy during assembly, particularly in large-scale serial production.

The connector can preferably be mounted directly in the waveguide and/or pre-assembled.

Due to the small, compact parts, the system is also highly suitable for industrialization and/or automation. For example, assembly can be carried out using standard pick-and-place machines.

By means of a bore in the connector, the waveguide can preferably be temporarily connected to the connector. By means of a bore in the connector, two waveguides can be mechanically stably and, in particular, temporarily connected.

It is preferably provided that the connector comprises or consists of steel, stainless steel, aluminum, brass, sheet metal, copper, iron, and/or a noble metal and/or is metallized or not metallized and/or is at least partially electrically conductive or non-conductive. The connector may also comprise or consist of a non-conductive material.

It is preferably provided that the waveguide comprises or consists of a dielectric waveguide, a hollow waveguide, an antenna, or an antenna array and/or comprises non-radiating slots.

It is preferably provided that the waveguide comprises or consists of plastic and/or is at least partially produced by injection molding, an additive manufacturing process, and/or milling and/or is metallized or not metallized.

The waveguide and/or the connector may also be implemented without metallization. In this way, the system of radio-frequency technology can be used for dielectric lines.

It is preferably provided that at least partially between the connector and the waveguide and/or the component there is arranged a, preferably anisotropic, conductive elastomer film.

The conductive elastomer film preferably has a thickness between 80 μm and 120 μm, in particular 100 μm.

It is preferably provided that the connector is soldered and/or glued to the component or is not soldered and/or not glued to the component.

It is conceivable that the connector is connected to the waveguide by means of a plug connection.

It is preferably provided that the connector is designed in such a way that heat transport between waveguide and component can take place.

The invention also relates to the use of a connector in a system of radio-frequency technology according to the invention. It is conceivable that the connector comprises or is a contour produced by shearing. The contour may additionally or alternatively comprise or be a pressed contour.

The invention also relates to a method for connecting a waveguide and a component with a connector for producing a system of radio-frequency technology according to the invention.

Preferably, the waveguide and/or the component are connected to the connector by means of a plug contact and/or a press-fit zone.

Automation of the method is also conceivable.

At this point it is noted that the terms “a” and “an” do not necessarily refer to exactly one of the elements, although this is a possible embodiment, but may also designate a plurality of the elements. Likewise, the use of the plural also includes the presence of the element in the singular, and vice versa, the singular also encompasses several of the relevant elements. Furthermore, all features of the invention described herein can be combined with one another in any way or claimed separately.

### BRIEF DESCRIPTION OF THE FIGURES

Further advantages, features and effects of the present invention will become apparent from the following description of preferred embodiments with reference to the figures, in which identical or similar components are designated by the same reference signs. The figures show in:

FIG. 1: a perspective view of a first embodiment of a system of radio-frequency technology according to the invention.

FIG. 2: a side view of the first embodiment of a system of radio-frequency technology according to the invention.

FIG. 3: a top view of the first embodiment of a system of radio-frequency technology according to the invention.

FIG. 4: a perspective view of a second embodiment of a system of radio-frequency technology according to the invention.

FIG. 5: a top view of the second embodiment of a system of radio-frequency technology according to the invention.

FIG. 6: a side view of the second embodiment of a system of radio-frequency technology according to the invention.

FIG. 7: a perspective view of a third embodiment of a system of radio-frequency technology according to the invention.

FIG. 8: a side view of the third embodiment of a system of radio-frequency technology according to the invention.

FIG. 9: a top view of the third embodiment of a system of radio-frequency technology according to the invention.

### DETAILED DESCRIPTION

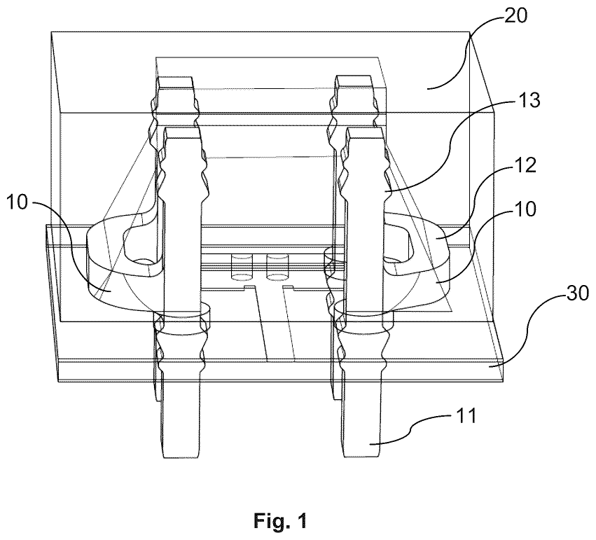

In FIG. 1, two stamped connectors 10 are shown, which connect a waveguide 20 to a circuit board 30. The waveguide 20 is shown semi-transparent in the figures.

The connectors 10 each comprise two pins 11 by means of which the connectors 10 are inserted into the circuit board 30. The pins 11 can be soldered in the circuit board 30 or merely inserted, pressed, and/or crimped into the circuit board 30.

The connectors 10 also each have a bow 12 by means of which the two pins 11 are connected. The connectors may also be single contacts.

A region of the pins 11 located in the waveguide 20 has projections 13 by means of which the waveguide 20 is connected to the connector 10, for example by clamping.

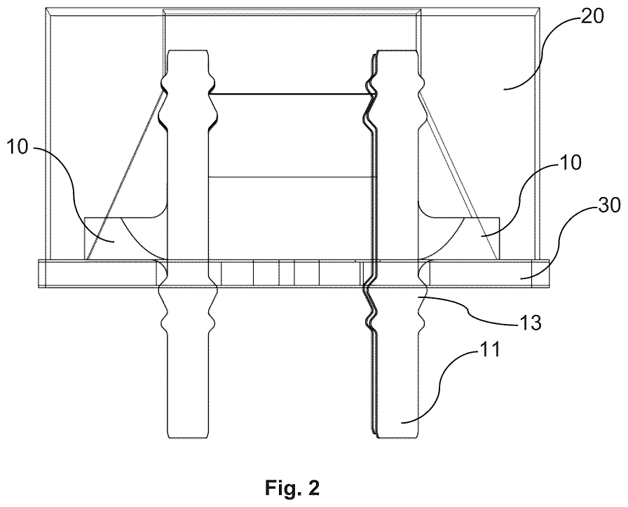

In FIG. 2, the pins 11 of the connectors 10 also have projections 13 in the region inserted into the circuit board.

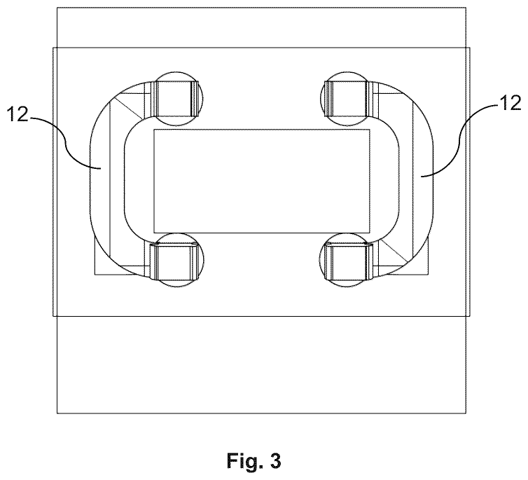

In FIG. 3, the formation of the bows 12 can be seen.

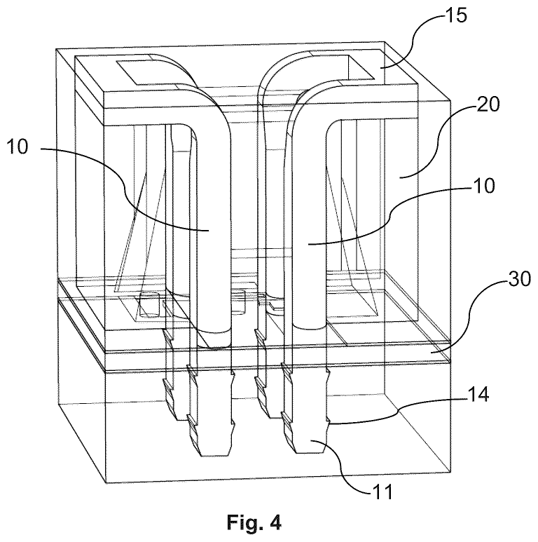

In FIG. 4, two stamped connectors 10 are shown, which connect a waveguide 20 to a circuit board 30.

The connectors 10 from FIG. 4 each have two bows with a web 15, by means of which the two pins 11 of the respective connectors 10 are connected. The two bows with a web 15 are arranged in or on the waveguide 20.

On the pins 11 of the connectors 10 from FIG. 4, barbs 14 or press-fit contacts are arranged, by means of which the pins 11 are held in bores of the circuit board 20.

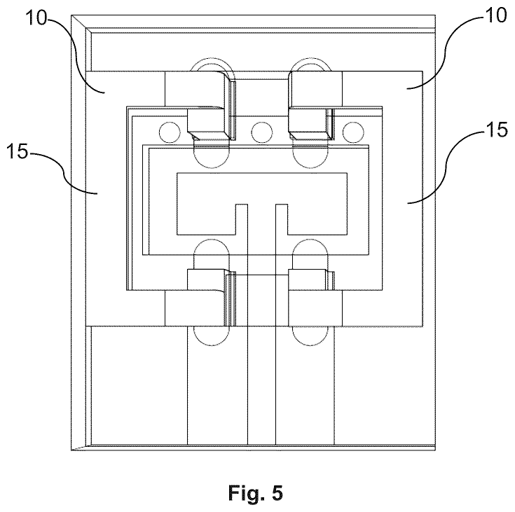

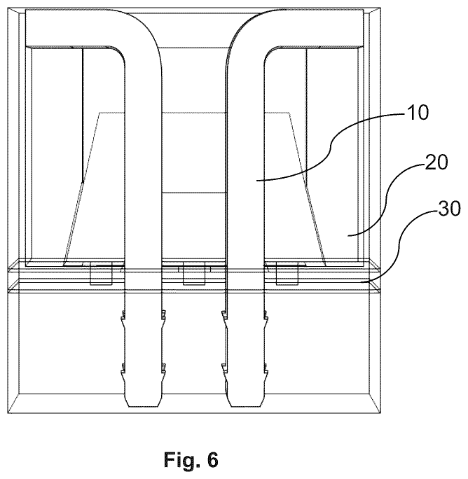

FIG. 5 shows a top view, and FIG. 6 a side view of the embodiment from FIG. 4.

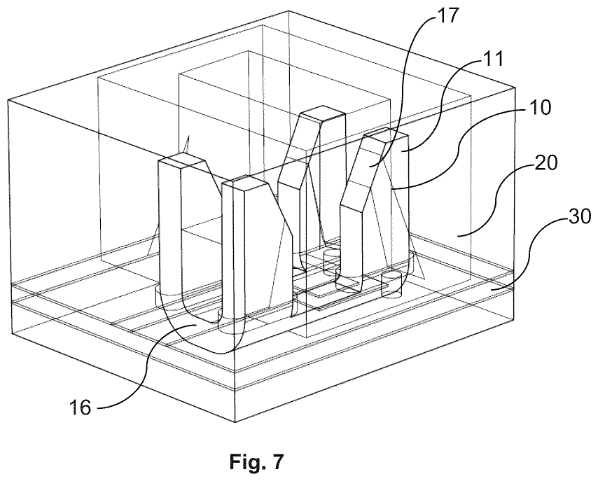

In FIG. 7, a stamped, pressed connector 10 is shown, which connects a waveguide 20 to a circuit board 30.

The connector 10 from FIG. 7 comprises four pins 11, which are arranged in or on the waveguide 20. The four pins 11 are connected by a bottom structure 16, which is arranged below the circuit board 20. The pins 11 each comprise a chamfer 17.

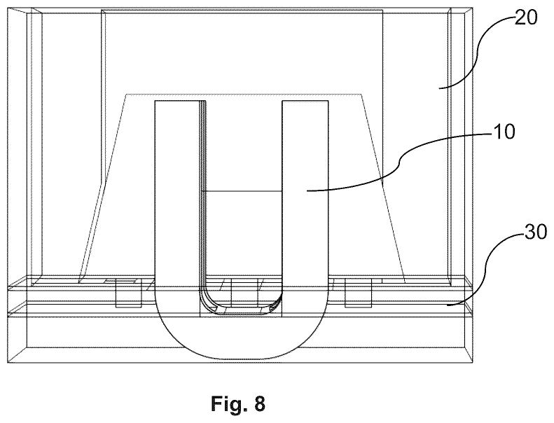

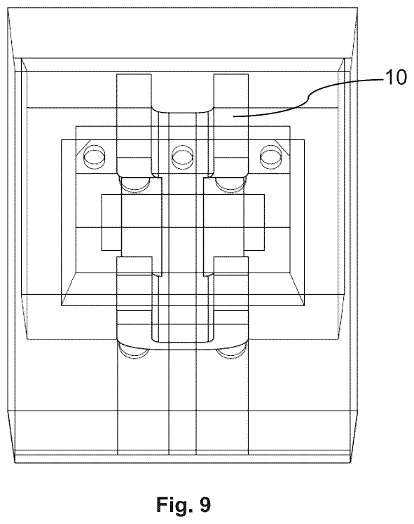

FIG. 8 shows a side view and FIG. 9 shows a top view of the embodiment of FIG. 7.

1. A system of radio-frequency technology comprising a waveguide, a component and a connector that is designed and arranged to establish a connection between the waveguide and the component, wherein the connection comprises a mechanical connection, and wherein the connection produced by the connector comprises a connection suitable for radio-frequency.

2. The system of radio-frequency technology according to claim 1, wherein the connector is a component which comprises or is a contour produced by shearing and/or laser cutting and/or a screw.

3. The system of radio-frequency technology according to claim 1, wherein the connection comprises an electrical connection.

4. The system of radio-frequency technology according to claim 1, wherein the component comprises or consists of a waveguide, a circuit board and/or a package, and/or is manufactured by an additive manufacturing process.

5. The system of radio-frequency technology according to claim 1, wherein the connector, the waveguide and/or the component comprise a bore.

6. The system of radio-frequency technology according to claim 1, wherein the connector comprises a plug contact, a press-fit zone and/or a barb.

7. The system of radio-frequency technology according to claim 1, wherein the connector comprises or consists of steel, stainless steel, aluminum, brass, sheet metal, copper, iron and/or a noble metal and/or is metallized or not metallized and/or is at least partially electrically conductive or non-conductive.

8. The system of radio-frequency technology according to claim 1, wherein the waveguide comprises or consists of a dielectric waveguide, a hollow waveguide, an antenna and/or an antenna array and/or comprises non-radiating slots.

9. The system of radio-frequency technology according to claim 1, wherein the waveguide comprises or consists of plastic and/or is at least partially produced by injection molding, an additive manufacturing process and/or milling and/or is metallized or not metallized.

10. The system of radio-frequency technology according to claim 1, wherein at least partially between the connector and the waveguide and/or the component, conductive elastomer film is arranged.

11. The system of radio-frequency technology according to claim 1, wherein the connector is soldered and/or glued to the component or is not soldered and/or not glued to the component.

12. The system of radio-frequency technology according to claim 1, wherein the connector is connected to the waveguide by means of a plug connection.

13. The system of radio-frequency technology according to claim 1, wherein the connector is designed in such a way that heat transport between waveguide and component can take place.

14. A use of a connector in the system of radio-frequency technology according to claim 1.

15. A method for connecting a waveguide and a component with a connector for producing the system of radio-frequency technology according to claim 1.

16. The method according to claim 15, wherein the waveguide and/or the component are connected to the connector by means of a plug contact.

17. The system of radio-frequency technology according to claim 10, wherein the conductive elastomer film is anisotropic.
